(19) United States
(12) Patent Application Publication
(10) Pub. No.: US 2009/0055201 A1
(43) Pub. Date: Feb. 26, 2009

(54) Virtual Reality Location Information System

(76) Inventors: Jamaal L. Washington, Blue Springs, MO (US); Calvin D. Straughter, Grand Prairie, TX (US)

Correspondence Address: JAMAAL WASHINGTON, 11124 LIBERTY FARMS DRIVE, AUSTIN, TX, 78754-5972, US

(21) Appl. No.: 11/842,240

(22) Filed: Aug. 21, 2007

(51) Int. Cl. G06Q 99/00

(52) U.S. Cl. 705/1

(57) ABSTRACT

A virtual reality location information system for touring various attractions through the Internet. The virtual reality location information system includes providing a host site, providing a first virtual business to represent a first actual business upon the host site, wherein the first virtual business mimics an appearance of the first actual business, providing a virtual city to represent an actual city upon the host site, wherein the virtual city mimics an appearance of the actual city, wherein the first virtual business is within the virtual city and providing at least one user. The user accesses the host site and creates a virtual member to mimic an appearance of the user. The user may then selectively navigate the virtual member through the first virtual business and tour the first virtual business.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to virtual tourism and more specifically it relates to a virtual reality location information system for touring various businesses through the Internet.

2. Description of the Related Art

Any discussion of the prior art throughout the specification should in no way be considered as an admission that such prior art is widely known or forms part of common general knowledge in the field.

Tourism and travel within a user's respective city and to various other cities has become increasingly popular throughout the years for various reasons, such as but not limited to various methods of transportation (e.g. airplane, automobile, etc.) and also an increase in awareness and interest in other people's cultures. When visiting a new area/city there are generally many choices of restaurants and nightclubs to choose from, wherein it can be difficult for a visitor of new area to find a specific type of business or attraction (e.g. restaurant, nightclub, hotel, museum, etc.).

Prior art has revealed some methods of informing visiting individuals of characteristics of different restaurants and nightclubs. Some of these methods include providing brochures, providing a website including basic information (e.g. location, culture of restaurant/nightclub, etc.) or various other advertisements.

Even though the brochures and basic websites list some information, it can be difficult to decipher specific information about the attraction without actually touring or visiting the attraction. Because of the general lack of efficiency and practicality in the prior art there is the need for a new and improved virtual reality location information system for touring various businesses through the Internet.

### BRIEF SUMMARY OF THE INVENTION

In view of the foregoing disadvantages inherent in the known types of virtual tourism now present in the prior art, the present invention provides a new virtual reality location information system wherein the same can be utilized for touring various locations through the Internet. The invention includes providing a host site, providing a first virtual business to represent a first actual business upon the host site, wherein the first virtual business mimics an appearance of the first actual business, providing a virtual city to represent an actual city upon the host site, wherein the virtual city mimics an appearance of the actual city, wherein the first virtual business is within the virtual city and providing at least one user. The user accesses the host site and creates a virtual member to mimic an appearance of the user. The user may then selectively navigate the virtual member through the first virtual business and tour the first virtual business.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a virtual reality location information system that will overcome the shortcomings of the prior art.

Another object is to provide a virtual reality location information system that provides a method to tour various attractions through the Internet.

An additional object is to provide a virtual reality location information system that allows access to members only.

A further object is to provide a virtual reality location information system that provides a subscription process for members to participate.

Another object is to provide a virtual reality location information system that allows a virtual member of a user to tour the various virtual businesses by virtually walking through the businesses.

Another object is to provide a virtual reality location information system that allows a virtual member to go from virtual business to another virtual business within a virtual city.

Another object is to provide a virtual reality location information system that provides an exact replica of an actual business through a virtual business.

Another object is to provide a virtual reality location information system that allows a virtual member of a user to tour the various virtual cities by virtually walking through the cities.

Another object is to provide a virtual reality location information system that provides an exact replica of an actual cities through a virtual city.

Another object is to provide a virtual reality location information system that is available for various types of attractions, such as but not limited to nightclubs, restaurants, hotels, museums and various others.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention in use with the virtual environment magnified from the computer.

FIG. 2 is a flowchart illustrating an overall process of the present invention.

FIG. 3 is a flowchart illustrating the process of logging into the host site and virtually entering a desired virtual business.

### DETAILED DESCRIPTION OF THE INVENTION

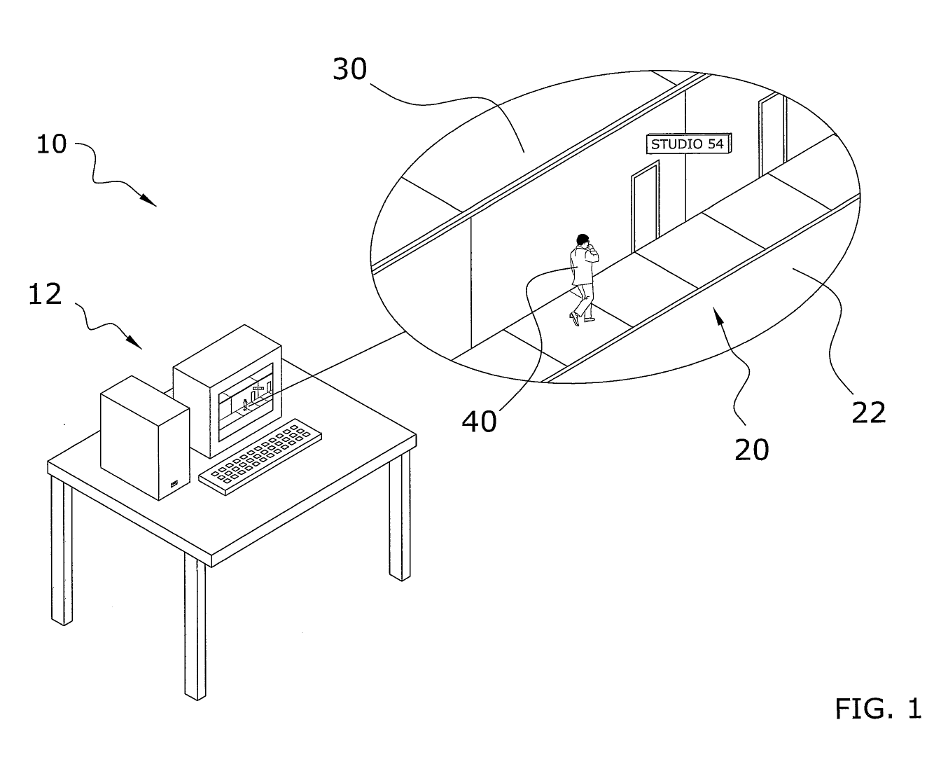

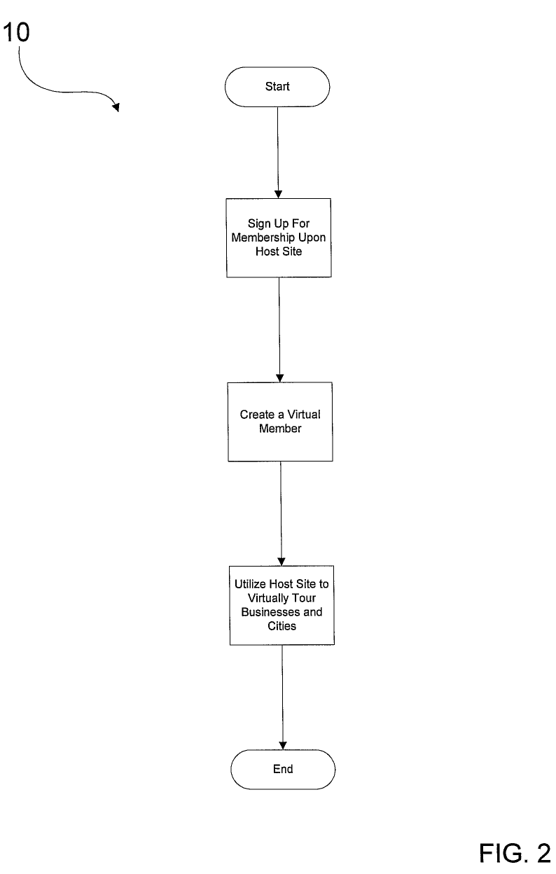

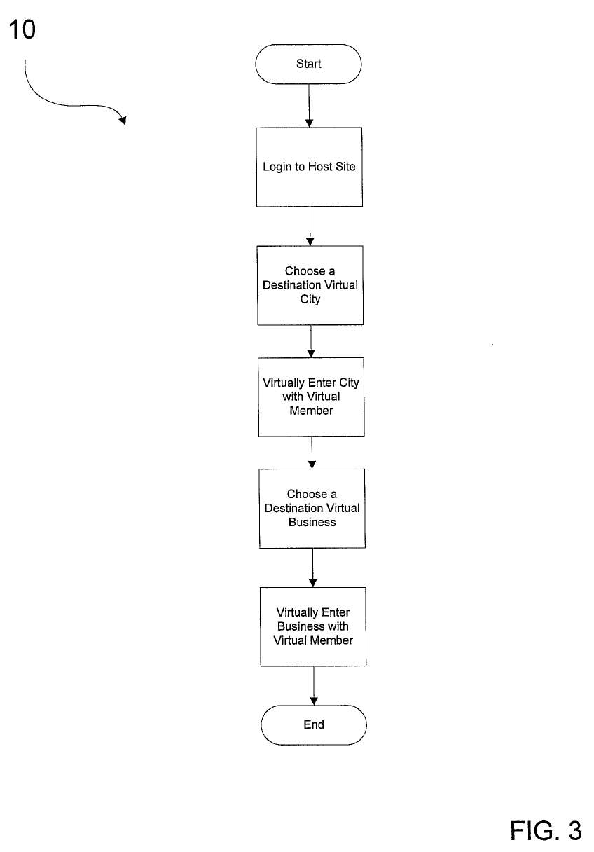

Turning now descriptively to the drawings, in which similar reference characters denote similar elements throughout the several view, FIGS. 1 through 3 illustrate a virtual reality location information system 10, which comprises providing a host site, providing a first virtual business 30 of at least one business upon the host site, providing at least one user, accessing the host site with the user and touring the first virtual business 30 of the business through the host site.

The host site of the present invention is comprised of a website or computer program operated via a computer 12 and capable of providing a virtual environment for the user to virtually tour via a virtual member 40. The host site will allow the users to virtually visit the virtual businesses 30 within the virtual city 20 without being at the actual business in person. The host site is also preferably connected to the Internet or a network of computers to allow users from various areas access to the host site (i.e. website, computer program, etc.).

The host site allows a client to display their actual business (e.g. nightclub, etc.) upon the host site, wherein a client may display pictures of the inside of their actual business, owner information, business type (e.g. bar, dance club, etc.) and various other information. The client preferably provides enough information and actual images (e.g. photos, etc.) to create a virtual environment of their respective actual business upon the host site.

The virtual city 20 also preferably mimics at least a portion of a respective actual city, wherein the virtual businesses 30 are positioned in a virtual outside environment 22 within the virtual city 20 substantially similar to the actual outside environment (i.e. location, proximity, etc.) of the actual business and the actual city. The virtual outside environment 22 preferably includes features commonly associated with city outside environments, such as sidewalks, streets, plants and various other features. The host site also preferably includes accurate details of various city destinations (e.g. cities, rural areas, etc.), such as but not limited to actual images or video of the various city destinations.

It is appreciated that the actual business utilized by the present invention may be comprised of various types of actual businesses, such as but not limited to night clubs (e.g. bars, dance clubs, etc.), restaurants and various other attractions (e.g. museums, zoos, etc.). It is also appreciated that the host site may also include a feature in which to send users text messages or other notifications of event information of a specific actual business. The event information may be provided by various sources, such as but not limited to the clients.

The clients are comprised individuals or companies that desire to make their actual business available to the virtual members 40 within the respective virtual city 20 in which their actual business is located. The clients subscribe to the host site to allow the virtual members 40 to virtually tour the respective virtual business 30. It is appreciated that the virtual city 20, the virtual business 30 and the virtual member 40 are each comprised of three-dimensional structures to provide a more life-like representation of the virtual member 40 being navigated through the virtual city 20 and the virtual business 30.

Posting the actual business upon the host site also serves as an advertising method for the client's actual business. The client may also pay to increase awareness of their respective virtual business 30 within the host site to allow a virtual member 40 to more easily find the client's virtual business 30.

The users preferably create profiles and upload images (e.g. pictures, etc.) of themselves to customize a profile page. The users also have the capability to design the virtual member 40 that will represent themselves while the virtual members 40 are touring the virtual businesses 30 and the virtual cities 20 within the host site.

In the preferred embodiment, each user will have the ability to choose a destination actual city of his or her choice as his or her home base. In the home base, virtual members 40 (i.e. virtual representations of the users) will be able to virtually walk the streets (i.e. virtual environment 22) of certain areas within the virtual city 20 viewing the many virtual businesses 30. Once a user chooses a virtual business 30 to enter, the virtual member 40 is navigated within the virtual business 30. Once the virtual member 40 is within the virtual business 30, it is appreciated that the user may navigate the virtual member 40 throughout the virtual business 30 or the user may automatically be shown a virtual tour of the virtual business 30.

The virtual member 40 may virtually visit various areas within the virtual business 30, such as but not limited to the VIP section. The virtual member 40 is thus able to virtually browse the inside of the virtual business 30 and make a more informed decision on whether or not to visit the respective actual business.

The user preferably is also able to view other virtual members 40 (rather than their own) currently being navigated within the virtual city 20 or the virtual business 30. Various users may subsequently virtually walk up to other users with a respective virtual member 40 and chat with the other users via instant messaging or other methods (e.g. talk through a microphone, etc.). In the present invention, different users logged onto the host site and virtually being navigated in a similar area will be able to virtually view each other in a similar manner as passing by somebody on the street or within a store of a real environment.

Users are also able to create various lists of other users (i.e. friends, etc.) on the host site to more easily keep in contact with the other users and also lists of favorite or top virtual businesses 30 within the host site. The lists may be comprised of various amounts (e.g. 10, 20, etc.) of friends (i.e. other virtual members 40) and favorite virtual businesses 30. The user may also take notes (i.e. via a virtual journal, etc.) of various aspects of the virtual business 30, such as but not limited to how the furniture is arranged with the color scheme.

The users can join the host site in various manners, such as but not limited to joining for free, purchasing value cards, a per use fee or various other payment requirements. In the preferred embodiment the value cards may be also be utilized as coupons or discount tickets to the various client businesses (e.g. nightclubs, etc.) when the user is actually visiting the business.

The value cards may be represented by different colors (e.g. gold, platinum, black, etc.). In the preferred embodiment a first value card will allow users to move to the front of the line of the actual business by presenting the first value card at the entrance of the actual business. A second value card will allow the users to move to front of the line at the entrance of the actual business and enter the business free of charge. The second value card will subsequently cost more than the first value card.

A third value card will allow users to move to the front of the line at the entrance of the actual business, enter the actual business free of charge as well as enter the VIP section of the actual business for free. It is appreciated that the value cards may include various choices and features rather than those listed. It is also appreciated that the value cards may not be utilized and various other methods of payment may be utilized by the user to join the host site.

In use, the user first signs up for membership to the host site. The user then creates a three-dimensional virtual member 40 to represent themselves while utilizing the present invention to virtually tour various virtual cities 20 and virtual businesses 30 within the virtual cities 20. The virtual member 40 created by the user preferably mimics the user in size and shape. When it is desired to virtually tour a virtual business 30 (e.g. nightclub, etc.), the user logs onto the host site utilizing various logging on methods (e.g. password, username, etc.). The user then selects a destination city (i.e. via typing in the city, etc.) in which the user will be visiting in the future or simply wants to know more about.

The virtual member 40 representing the user now enters the virtual city 20, wherein the user navigates the virtual member 40 within the virtual outside environment 22 of the virtual city 20 (e.g. along the sidewalk of the virtual city 20, etc.). When coming upon a virtual business 30 that has registered as a client with the host site, the user will have a choice on whether or not to enter the virtual business 30 with their virtual member 40. If the user desires to enter the virtual business 30, the virtual member 40 is navigated within the virtual business 30 and the inside of the virtual business 30 is displayed to the user. It is also appreciated that a list of virtual businesses 30 available for the user to tour may be provided when first entering the virtual city 20 rather than having to navigate the virtual member 40 throughout the virtual outside environment 22 of the virtual city 20.

The user may now view various areas of the inside of the virtual business 30 via navigating the virtual member 40 through the inside of the virtual business 30. It is appreciated that various other information (e.g. owner information, etc.) is displayed to the user upon the computer 12. When the user is finished viewing the respective virtual business 30, the user may navigate the virtual member 40 out of the currently viewed virtual business 30 (i.e. first virtual business) and back within the virtual outside environment 22.

The virtual member 40 is now navigated within the virtual environment 22 towards another (i.e. second) virtual business 30. The virtual member 40 may subsequently navigate the virtual member 40 within the second virtual business 30 and repeat the touring process. The virtual member 40 may subsequently be navigated to a plurality of other virtual businesses 30 repeating the previously described process.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

We claim:

1. A method for a virtual reality location information systemu, comprising:
providing a host site;
providing a first virtual business to represent a first actual business upon said host site, wherein said first virtual business mimics an appearance of said first actual business;
providing a virtual city to represent an actual city upon said host site, wherein said virtual city mimics an appearance of said actual city, wherein said first virtual business is within said virtual city;
providing at least one user;
accessing said host site with said at least one user;
creating a virtual member to mimic an appearance of said at least one user;
selectively navigating said virtual member through said first virtual business with said at least one user; and
touring said first virtual business with said virtual member.

2. The method for a virtual reality location information system of claim 1, wherein said virtual member virtually walks through said first virtual business.

3. The method for a virtual reality location information system of claim 1, wherein said virtual member virtually enters said virtual city prior to said first virtual business.

4. The method for a virtual reality location information system of claim 1, wherein said virtual member is selectively navigated through said virtual city.

5. The method for a virtual reality location information system of claim 4, wherein said virtual member virtually walks through said virtual city.

6. The method for a virtual reality location information system of claim 1, wherein said first actual business is comprised of a nightclub.

7. The method for a virtual reality location information system of claim 1, wherein said host site is comprised of a website.

8. The method for a virtual reality location information system of claim 7, wherein said at least one user accesses said host site via a computer connected to the Internet.

9. A method for a virtual reality location information systemu, comprising:
providing a host site;
providing a first virtual business to represent a first actual business upon said host site, wherein said first virtual business mimics an appearance of said first actual business;
providing a second virtual business to represent a second actual business upon said host site, wherein said second virtual business mimics an appearance of said second actual business;
providing a virtual city to represent an actual city upon said host site, wherein said virtual city mimics an appearance of said actual city, wherein said first virtual business and said second virtual business are within said virtual city;
providing at least one user;
accessing said host site with said at least one user;
creating a virtual member to mimic an appearance of said at least one user; and
selectively navigating said virtual member through said first virtual business with said at least one user.

10. The method for a virtual reality location information system of claim 9, wherein said virtual member virtually walks through said first virtual business.

11. The method for a virtual reality location information system of claim 9, wherein said virtual member virtually enters said virtual city prior to said first virtual business.

12. The method for a virtual reality location information system of claim 11, wherein said virtual member virtually walks through said virtual city.

13. The method for a virtual reality location information system of claim 9, wherein said virtual member virtually exits said first virtual business and enters said second virtual business.

14. The method for a virtual reality location information system of claim 13, wherein said virtual member is able to virtually walk from said first virtual business to said second virtual business.

15. The method for a virtual reality location information system of claim 9, wherein said virtual member virtually exits said first virtual business and enters a virtual outside environment of said virtual city.

16. The method for a virtual reality location information system of claim 15, wherein said virtual member is able to virtually walk within said virtual outside environment between said first virtual business and said second virtual business.

17. The method for a virtual reality location information system of claim 16, wherein said virtual member virtually enters said second virtual business from said virtual outside environment.

18. The method for a virtual reality location information system of claim 9, wherein said first actual business and said second actual business are comprised of nightclubs.

19. The method for a virtual reality location information system of claim 9, wherein said host site is comprised of a website.

20. A method for a virtual reality location information systemu, comprising:
providing a host site;
providing a first virtual business to represent a first actual business upon said host site, wherein said first virtual business mimics an appearance of said first actual business;
providing a virtual city to represent an actual city upon said host site, wherein said virtual city mimics an appearance of said actual city, wherein said first virtual business is within said virtual city;
providing a virtual outside environment within said virtual city;
providing at least one user;
accessing said host site with said at least one user;
creating a virtual member to mimic an appearance of said at least one user;
selectively navigating said virtual member through said virtual outside environment of said virtual city, wherein said virtual member virtually walks through said virtual outside environment;
selectively navigating said virtual member within said first virtual business, wherein said virtual member virtually walks through said first virtual business;
touring said first virtual business with said virtual member;
selectively navigating said virtual member out of said first virtual business;
reentering said virtual outside environment of said virtual city;
virtually walking within said virtual outside environment with said virtual member;
providing a second virtual business to represent a second actual business upon said host site, wherein said second virtual business mimics an appearance of said second actual business;
selectively navigating said virtual member within said second virtual business, wherein said virtual member virtually walks through said second virtual business;
touring said second virtual business with said virtual member; and
selectively navigating said virtual member out of said second virtual business.
